(19) United States
(12) Patent Application Publication
(10) Pub. No.: US 2019/0137038 A1
(43) Pub. Date: May 9, 2019

(54) HYDROGEN FILLING STATION WITH LIQUID HYDROGEN

(71) Applicant: LINDE AKTIENGESELLSCHAFT, München (DE)

(72) Inventors: Wilfried-Henning Reese, Unterschleißheim (DE); Tobias Kederer, Egling-Aufhofen (DE); Martin Brücklmeier, Icking (DE); Roland Szardenings, Wolfratshausen (DE); Simon Schäfer, Pullach (DE)

(73) Assignee: LINDE AKTIENGESELLSCHAFT, München (DE)

(21) Appl. No.: 16/095,786

(22) PCT Filed: Apr. 6, 2017
(86) PCT No.: PCT/EP17/00431

§ 371 Date: Oct. 23, 2018

(30) Foreign Application Priority Data
Apr. 28, 2016 (DE) 102016005217.1

(51) Int. Cl. F17C 5/02; F17C 13/00; F17C 13/04; F17C 7/02

(52) U.S. Cl. CPC F17C 5/02; F17C 2270/0139; F17C 13/04; F17C 7/02; F17C 2221/012; F17C 2227/0135; F17C 2203/03; F17C 2205/0323; F17C 2205/0352; F17C 2223/0161; F17C 2223/035; F17C 2223/036; F17C 2223/043; F17C 2227/0339; F17C 2227/0381; F17C 2265/031; F17C 2265/065; F17C 13/001

(57) ABSTRACT

A supply device and a method for building and operating a supply device of a filling station for liquid hydrogen are disclosed. The supply device has at least one storage tank for liquid hydrogen, and at least one pump for liquid hydrogen, the storage tank and pump being directly interconnected.

The invention relates to a supply device of a filling station for liquid hydrogen, which comprises at least one storage tank and at least one pump, as well as to a method for configuring and operating such a supply device.

Supply devices for filling stations typically comprise a supply or storage tank and a pump for withdrawing the fluid from the storage tank and/or for increasing the pressure of the fluid for the refueling process.

The storage tank or storage tanks are connected to the pump via a pipeline. This pipeline is typically interrupted by shut-off valves or control valves and control fittings. The connection between the components, particularly between the storage tank and the pump, is typically not produced until the on-site installation.

In order to ensure the assembly of these components, the pipeline must have a certain length such that the pipeline is accessible and at least one technician can work on the connection between the storage tank and the pump. It furthermore has to be ensured that valves and other components can be checked and optionally replaced.

Despite an insulation of the pipeline, it is disadvantageous that the amount of heat introduced into the system increases proportionally with the length of the pipeline. When heat is introduced into liquid hydrogen, a gaseous phase (in the following also referred to as boil-off gas) is formed due to evaporation losses and can, among other things, lead to a pressure increase in the system, production losses or damages of the downstream components of the supply device, particularly the pump.

Heat can also be introduced due to the thermal conduction of components of valves and other instruments such as temperature or pressure sensors, which are in contact with the environment, as well as with the interior of a pipeline for the fluid or directly with the pipeline f the fluid or the fluid zone within a storage tank.

The present invention is based on the objective of disclosing a device and a method for reducing the heat introduction into the supply device of a filling station for liquid hydrogen.

This objective is attained in that the storage tank and the pump are directly interconnected. In this context, it is advantageous that no valves or instruments, which could interrupt the pipeline between the outlet of the storage tank and the low-pressure zone of the pump, are arranged between the outer shell of the storage tank and the pump.

The pipeline length of the connection between the storage tank and the pump advantageously lies between 0.01 and 3 m, particularly between 0.5 and 1 m, especially between 0.63 and 0.78 m. The connection between the storage tank and the pump, i.e. the discharge line for the fluid, particularly for liquid hydrogen, should be as short as possible. The shorter the discharge line, the less heat can be introduced into the supply device.

The discharge line, i.e. the line for conveying, in particular, liquid hydrogen from the storage tank to the pump, preferably has a length of 0.63 m.

Cold boil-off gas is advantageously returned into the storage tank. This return line preferably has a length of 0.78 m.

The storage tank advantageously consists of a thermally insulated region that surrounds a fluid container.

The storage tank and therefore also the fluid container are preferably realized in such a way that liquid hydrogen can be stored therein. A gaseous phase of the hydrogen is formed above the fluid level.

The thermally insulated region serves for keeping the temperature within the fluid container constant. An insulating material in the form of a filling may be introduced therein or said region may be evacuated or consist of different layer materials. A combination of different insulating techniques is also conceivable.

The storage tank advantageously comprises a supply line for liquid hydrogen. This supply line is advantageously secured by means of shut-off valves and/or pressure retention valves that are preferably integrated into the thermally insulated region. In a preferred embodiment, the storage tank comprises temperature and pressure sensors, as well as other safety devices.

Valves required for filling, degassing and shutting off a low-pressure zone of the pump are advantageously integrated into the thermally insulated region of the storage tank. This has the advantage that the low temperature prevailing at this location can also be used for cooling the valves. These valves furthermore make it possible to isolate the storage tank from the pump. This may be necessary, in particular, when the storage tank is filled or the pump is serviced. Control elements such as levers and displays of the valves and sensors, which are advantageously integrated into the thermally insulated region, are in contact with the environment of the storage tank and just like pipelines contribute to the introduction of heat into the fluid zone of the storage tank or into the thermally insulated region due to thermal conduction.

In a preferred embodiment of the supply device, valves and other instruments of the storage tank, which protrude from the environment of the storage tank into a fluid zone of the storage tank, are therefore connected to an intermediate cooling arrangement within the thermally insulated region.

The intermediate cooling arrangement may be realized in such a way that a pipeline extends past the thermally conductive components of the valves or sensors within the thermally insulated region, but in the vicinity of the outer wall of the storage tank. The pipeline may also extend around these components in the form of one or more coils.

A gas (boil-off gas) formed due to evaporation losses is advantageously used for intermediately cooling valves and the thermally insulated region. The boil-off gas is advantageously withdrawn from the gas zone of the fluid container and fed to the intermediate cooling arrangement via a pipeline. This pipeline is preferably also arranged within the thermally insulated region such that this region is also cooled.

Boil-off gas is formed due to the introduction of heat into the storage tank and, in particular, the evaporation of the liquid hydrogen. Boil-off gas has to be discharged from the storage tank in order to prevent a pressure increase. However, the boil-off gas has a low temperature similar to the liquid hydrogen and therefore can be used for cooling purposes.

The boil-off gas is initially used for cooling the thermally insulated region and the equipment arranged therein, but can also be used for cooling downstream components of the filling station after it has been discharged from the storage tank. The thermodynamic efficiency of the complete system, i.e. the filling station, is thereby optimized.

Subsequently, the boil-off gas can be once again cooled and/or liquefied and returned into the storage tank. In another embodiment, the boil-off gas can also be discarded and, for example, released into the environment or burned.

The pump is advantageously realized in such a way that it can convey and/or compress liquid hydrogen. The pump is particularly designed for conveying hydrogen, as well as for its compression, i.e. for increasing its pressure. The pump advantageously increases the pressure of the liquid hydrogen to 50 to 1000 bar, particularly to 350 to 500 bar or 700 or 900 bar.

In another advantageous embodiment of the supply device, the pump, particularly a low-pressure zone of the pump, is installed within the thermally insulated region of the storage tank or directly in the fluid container of the storage tank.

The liquid hydrogen is preferably stored and/or conveyed at a temperature between 20 K and 27.5 K, particularly between 22.5 K and 24 K. This means that the temperature in the interior of the storage tank lies between 20 K and 27.5 K whereas an ambient temperature typically prevails outside the storage tank.

A particular advantage of the direct connection of the storage tank to the pump can be seen in that the installation area is reduced. Although the assembly typically has to be carried out at a different location, this provides the additional advantage that superior insulating options are available at a factory. In this way, it can be ensured that particularly the transitions of the thermal insulating regions between the storage tank, the pump and the connecting pipeline are realized without defects. It would even be possible to create a common insulating shell of a continuous material. The heat introduction is thereby significantly reduced. Boil-off gas is prevented from forming in the connecting line between the storage tank and the pump and thereby from damaging the pump, particularly due to bubbling or cavitation.

Due to the preassembly in a factory, the assembly time at the installation site can also be reduced such that additional cost savings are realized.

A preassembly is also particularly helpful if the supply unit should be installed below ground such that access thereto is restricted even more than in an above-ground installation.

The supply device is particularly suitable for use in filling stations for supplying vehicles with hydrogen or natural gas.

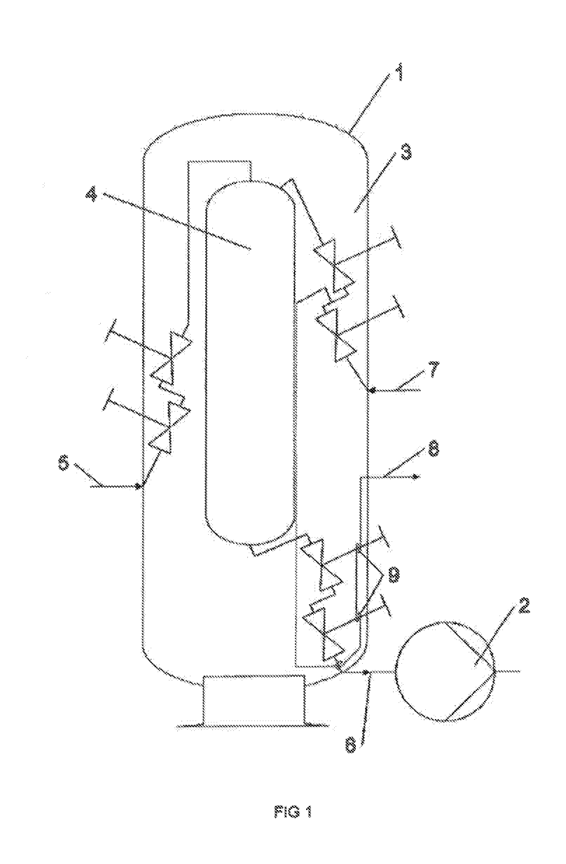

The invention is described in greater detail below with reference to an exemplary embodiment that is schematically illustrated in FIG. 1.

FIG. 1 schematically shows an embodiment of the inventive device. The storage tank 1 and the pump 2 preferably form parts of a hydrogen filling station for refueling vehicles.

The storage tank 1 is composed of a thermally insulated region 3 and a fluid container 4. The fluid container is designed for storing liquefied hydrogen, wherein a gas atmosphere containing hydrogen is formed above the fluid level.

In this exemplary embodiment, the thermally insulated region 3 is insulated by means of a filling and an applied vacuum. All valves and safety and control devices of the storage tank 1 are accommodated in the thermally insulated region in such a way that the least amount of heat possible is introduced into the thermally insulated region via the externally accessible handles, levers or displays. This is particularly achieved in that cold boil-off gas is conveyed past the valves within the thermally insulated region 3 such that these valves are cooled. This is schematically indicated with the intermediate cooling arrangement 9 in three exemplary positions. The introduction of heat via valve handles, sensors or other lines extending into the thermally insulated region 3 from outside is therefore largely prevented. The boil-off gas is removed from the storage container via the discharge line 8. The boil-off gas can be used for cooling other system components, discarded or once again cooled.

The storage tank 1 comprises a supply line 5 for a fluid, in this example for liquid hydrogen. Among other things, the supply line 5 is secured by means of shut-off valves and pressure retention valves.

The storage tank 1 is connected to the pump 2 via the discharge line 6 for liquid hydrogen. The pump 2 is preferably realized in the form of a cryopump for handling liquid hydrogen.

The discharge line 6 is secured, among other things, by means of shut-off valves and pressure retention valves. In this exemplary embodiment, conditioned and cooled boil-off gas is returned into the storage tank 1 via the return line 7 and either directly used for cooling purposes again or conveyed into the gas zone in the top section of the fluid container 4. In this way, the gas zone in the top section of the fluid container 4 can be cooled and/or its pressure can be influenced.

In the exemplary embodiment shown, the discharge line 6 between the storage tank 1 and the pump 2 has a length of 0.63 m. This narrow spacing ensures that the least amount of heat possible is introduced.

The system is preassembled in order to reduce the on-site assembly effort caused by the small spacing.

### List of Reference Symbols

1 Storage tank
2 Pump
3 Thermally insulated region
4 Fluid container
5 Fluid supply line
6 Fluid discharge line
7 Gas return line
8 Boil-off gas discharge line
9 Intermediate cooling

1. A supply device of a filling station for liquid hydrogen, comprising at least one storage tank and at least one pump, characterized in that the storage tank and the pump are directly interconnected.

2. The supply device according to claim 1, characterized in that the pipeline length of the connection between the storage tank and the pump lies between 0.01 and 3 m.

3. The supply device according to claim 1, characterized in that valves required for filling, degassing and shutting off a low-pressure zone of the pump are integrated into the thermally insulated region of the storage tank.

4. The supply device according to claim 1, characterized in that valves and other instruments of the storage tank, which protrude from the environment of the storage tank into a fluid zone of the storage tank, are connected to an intermediate cooling arrangement within the thermally insulated region.

5. A method for configuring and operating a supply device of a filling station for liquid hydrogen, which comprises at least one storage tank for liquid hydrogen and at least one pump for liquid hydrogen, characterized in that the storage tank and the pump are directly interconnected.

6. The method according to claim 5, characterized in that a gas formed due to evaporation losses is used for intermediately cooling valves and the thermally insulated region.

7. The method according to claim 5, characterized in that the liquid hydrogen is stored and/or conveyed at a temperature between 21.5 K and 27.5 K.

8. The method according to claim 5, characterized in that the pump increases the pressure of the liquid hydrogen to 50 to 1000 bar.

9. The method according to claim 7, characterized in that the liquid hydrogen is stored and/or conveyed at a temperature between 21.5 K and 24 K.

10. The method according to claim 8, characterized in that the pump increases the pressure of the liquid hydrogen to 350 to 900 bar.

11. The method according to claim 8, characterized in that the pump increases the pressure of the liquid hydrogen to 350 to 700 bar.

12. The method according to claim 8, characterized in that the pump increases the pressure of the liquid hydrogen to 350 to 500 bar.
